(19) United States
(12) Patent Application Publication
(10) Pub. No.: US 2015/0312368 A1
(43) Pub. Date: Oct. 29, 2015

(54) DATA CACHE ON A CLOUD PLATFORM

(71) Applicant: EMPIRE TECHNOLOGY DEVELOPMENT LLC, Wilmington, DE (US)

(72) Inventors: Shijie XU, Beijing (CN); Qi LI, Beijing (CN); Xuefong SONG, Shijiazhuang (CN)

(21) Appl. No.: 14/648,349

(22) PCT Filed: Aug. 29, 2013
(86) PCT No.: PCT/CN2013/081165

§ 371 Date: May 29, 2015

(51) Int. Cl. H04L 29/08

(52) U.S. Cl. CPC H04L 67/2842

(57) ABSTRACT

In some examples, a data storage on a cloud platform may be configured to provide cloud services access to general data while preserving the access right to private data. General data is accessible to all applications. The identity information of applications that may access private data may be stored on the data storage. When the identity information of a requesting application matches the identity information stored on the data storage, the cloud platform may grant the access to private data.

### TECHNICAL FIELD

The technologies described herein pertain generally to a hierarchical data storage system on a cloud platform.

### BACKGROUND

Unless otherwise indicated herein, the approaches described in this section are not prior art to the claims in this application and are not admitted to be prior art by inclusion in this section.

Applications, provided by respective online services, that are executed or otherwise hosted on client devices may request data stored on a common cloud platform. Multiple applications may access one or more of the same portions of data cached on or by the common cloud platform.

### SUMMARY

Technologies are generally described for data cache on a cloud platform. The various embodiments may be implemented in various devices, methods and/or systems.

In some examples, various embodiments may be implemented as devices. Some devices may include a service memory that includes one or more cells, each of which is configured to store unique identifiers corresponding to respective ones of a portion of plural applications; and a data storage that is configured to store general data that is accessible to the plural applications, and store private data that is generated by a first one of the plural applications and is accessible to the portion of the plural applications based on verification of a corresponding one of the unique identifiers.

In some examples, various embodiments may be implemented as methods. Some methods may include storing general data on a data storage of a cloud cache; storing private data on the data storage of the cloud cache; storing one or more unique identifiers, each of which identifies one of a subset of applications, on a service memory of the cloud cache; receiving one or more requests, from a requesting application, to access the private data; granting access to the private data when identity information included in the one or more requests received from the requesting application matches one of the stored one or more unique identifiers; and granting access to the general data when the identity information included in the one or more requests received from the requesting application does not match any of the one or more unique identifiers.

In some examples, various embodiments may be implemented as computer-readable mediums having executable instructions stored thereon. Some computer-readable mediums may store instructions that, when executed, cause one or more processors to perform operations comprising automatically storing general data on a data storage of a cloud cache; storing private data on the data storage in response to one or more instructions from one or more applications that generated the private data; storing one or more unique identifiers, each of which identifies one of a subset of applications, on a service memory of the cloud cache; receiving one or more requests, from a requesting application, to access the private data; and granting access to the private data when identity information included in the one or more requests received from the requesting application matches one of the stored one or more unique identifiers.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items. In the drawings:

FIG. 1 shows an example system in which a data cache on a cloud platform may be implemented, arranged in accordance with at least some embodiments described herein;

FIG. 2 shows an example cloud cache device by which a data cache on a cloud platform may be implemented, arranged in accordance with at least some embodiments described herein;

FIG. 3 shows an example configuration of a processing flow of operations by which data caching on a cloud platform may be implemented, arranged in accordance with at least some embodiments described herein; and

FIG. 4 shows a block diagram illustrating an example computing device that is arranged for data cache on a cloud platform, arranged in accordance with at least some embodiments described herein.

### DETAILED DESCRIPTION

In the following detailed description, references are made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Due to the commonality of data sources used by related cloud services, the present detailed description pertains generally to a data storage device that provides cloud services access to public data, referenced as “general data” herein, while also providing the access right to private data to one or more limited applications. In some examples, the data storage device may adopt at least a two-level hierarchy to store general data and private data. At the top layer of the hierarchy, data may be indexed by a hash value of a Universally Unique Identifier (UUID) of the applications that have access to private data. At the bottom layer of the hierarchy, data may be indexed by a hash value of the general data or the private data. Only the applications whose UUIDs are stored in the top layer of the hierarchy may access the private data.

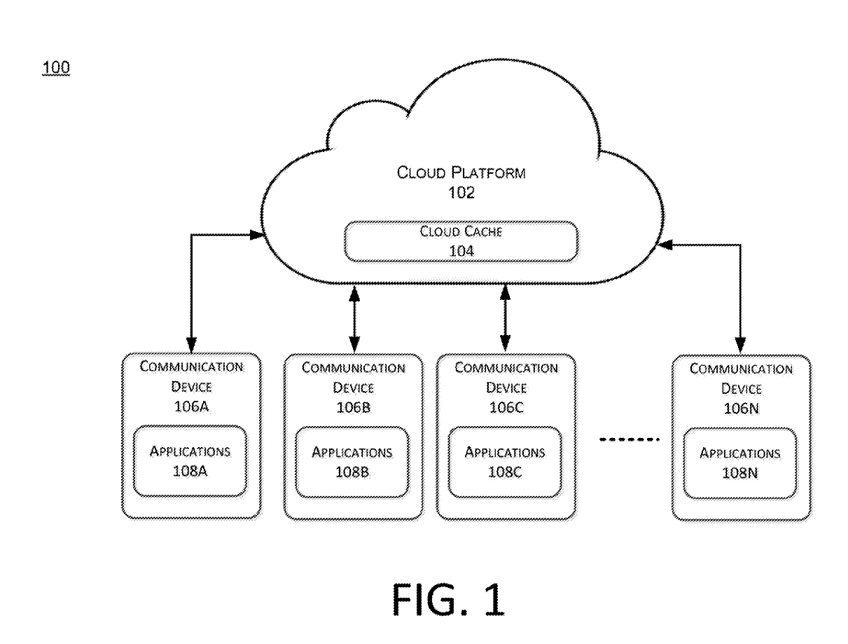

FIG. 1 shows an example system 100 in which a data cache on a cloud platform may be implemented, arranged in accordance with at least some embodiments described herein. As depicted, example system 100 may include a cloud platform 102 that includes a cloud cache 104, and one or more communication devices 106A-106N that are communicatively coupled to cloud platform 102. Each of communication devices 106A-106N may host one or more of applications 108A-108N. Unless context requires specific reference to one or more of communication devices 106A-106N, collective reference may be made to “communication devices 106” as used herein; similarly, collective reference may be made to “applications 108” below.

Cloud platform 102 may refer to a grouping of computing devices, e.g., servers and/or personal computers, that are communicatively coupled to each other in various permutations thereof. Cloud platform 102 may be configured to perform computing tasks requested by, or otherwise submitted from, one or more of communication devices 106. The computing tasks may be separated into a number of portions that may be further distributed to one or more of the grouping of computing devices that make up cloud platform 102 for computing. Thus, complicated computing tasks do not require expensive supercomputers or infrastructure and, therefore, reduce the financial and infrastructure cost of computing.

Cloud cache 104 may refer to one or more data storage devices that may be configured to store data generated by one or more of applications 108 or by cloud platform 102, and to identity information of at least one of applications 108 that may be granted access the stored data. The one or more data storage places may refer to physical memory devices located on different ones of the group of computing devices or disk storage and/or network storage distributed over cloud platform 102, which may be communicatively coupled to the different ones of the group of computing devices. The physical memory devices may refer to memory devices of low latency and high transfer rate such that reading data from the physical memory devices may take less time than from traditional hard disks. Examples of the physical memory devices may include Solid State Disk (SSD), Random Access Memory (RAM), and other forms of memory devices that eliminate motorized physical disk-shaped components; and examples of the aforementioned high transfer rate may be over 1 gigabyte per second. The disk storage may be configured to store large amount of data objects while network storage may be configured to store application data and/or cloud data for high reliability and performance.

Data stored in cloud cache 104 may be categorized into, e.g., general data and private data.

General data may refer to data that is accessible to all of applications 108 in response to one or more access requests from one or more versions or instances of service 108 that are hosted on corresponding ones of communication devices 106. An example of general data may include a temperature value of a certain geographic location, as determined and stored by a common source, e.g., National Weather Service, that may be accessed by different weather applications, i.e., applications 108, such as The Weather Channel®, Weather Bug®, or One Weather.

Private data may refer to data that is accessible to a limited number of applications 108 that are hosted on corresponding ones of communication devices 106. Private data may refer to data that is not generally accessible or available to all applications 108. Examples of private data may include a pinpoint geographical location of the user who requests weather information, which may be accessible to one of applications 108 or may be accessible to some limited applications authorized by the application that generated the private data. Such accessibility may or may not be exclusive.

Communication devices 106 may refer to one or more client devices that are communicatively coupled to cloud platform 102 and that are each configured to host one or more software applications, e.g., applications 108. Communication devices 106 may include one or more hardware components including, but not limited to, Central Processing Units (CPUs), physical storage devices, memory devices, network ports, etc., to collect or generate general data and/or private data. For example, when application 108A hosted by communication device 106A corresponds to one of applications 108A, e.g., a weather forecast application, communication device 106A may be configured to submit one or more access requests for weather forecast data that is stored on cloud platform 102. Then, when cloud platform 102 grants the one or more access requests, communication device 106A may retrieve the weather forecast data from cloud platform 102 and transmit the retrieved weather forecast data to the weather forecast application. The weather forecast application may then process and convert the weather forecast data into perceivable contents for a user.

Applications 108 may refer to one or more software applications, versions or instances of which may be hosted on communication devices 106, and that may be configured to perform computing tasks in response to a user's requests input thereto. In accordance with some examples, applications 108 may include a weather forecast application that may be configured to retrieve weather forecast data with respect to a general geographic location of a user from cloud platform 102. The weather forecast data may include past, current, and future readings of temperature, humidity, wind speed, ultra-violet (UV) index, etc.

Thus, FIG. 1 shows an example system 100, in which data cache on a cloud platform may be implemented, that may include cloud platform 102, cloud cache 104, and communication devices 106 that host application 108.

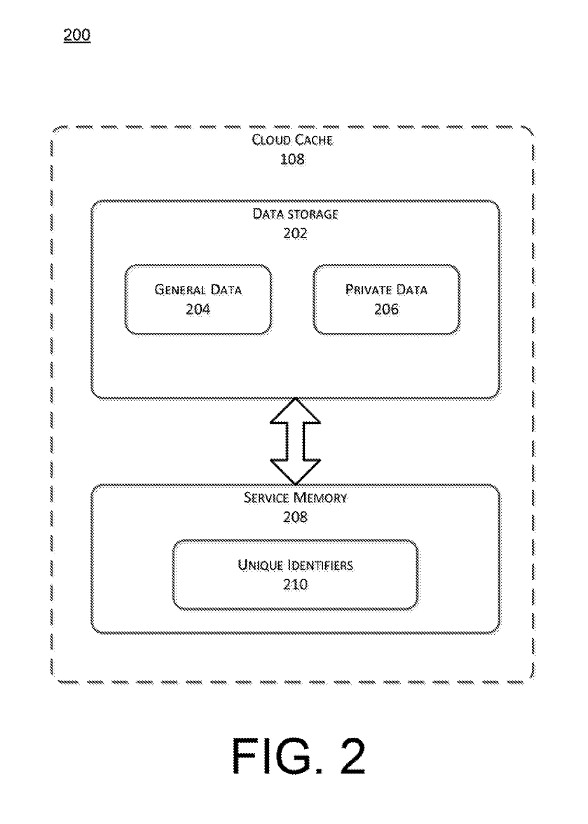

FIG. 2 shows an example cloud cache 108 device by which a data cache on a cloud platform may be implemented, arranged in accordance with at least some embodiments described herein. As depicted, example cloud cache 108 may include a data storage 202 that is configured to store general data 204 and private data 206, and a service memory 208 that is configured to store one or more unique identifiers 210.

Data storage 202 may refer to one or more physical memory devices distributed on different ones of the grouping of computing devices that make up cloud platform 102. Data storage 202 may be configured to store data, which may be collected or generated by one or more of applications 108. In accordance with some example, data stored in or at data storage 202 may be indexed in accordance with a hash value of the data.

As referenced herein, “index” may refer to storing the hash value of the data in a data structure that improves the speed of data retrieval operations on a database table at the cost of slower writing operations and more storage space.

As referenced herein, “hash value” may refer to the output of a hash function of input that may include the data or corresponding ones of unique identifiers 210. A hash function may refer to any algorithm that maps large data sets of variable length to smaller data sets of a fixed length.

General data 204 may refer to the data that may be the same in response to one or more requests to access from different versions and/or instances of applications 108 and that may be accessible to all of applications 108. For example, a temperature value of a general geographic location may be the same for the aforementioned different applications. The temperature value may be collected by The National Weather Service and may be stored on data storage 202 as part of general data 204, thus others of applications 108 may access the temperature value without permission from the application that first requested the temperature value, e.g., The Weather Channel®. In accordance with some examples, non-limiting examples of general data 204 may include traffic information of a certain area, routing information from one place to a destination, or a map. In other examples, cloud platform 102 may adopt a filtering process to determine whether the data collected or generated may be common to other applications and, thus, may be categorized as general data.

Private data 206 may refer to data that is accessible to a limited number of applications 108 that generated or collected the data and other applications authorized by the one or more of applications 108 to access the data. Private data 206 may include information such as pinpoint geographical location of a user that may not be accessible to other applications or may be accessible to some limited applications authorized by the application that generated the private data. As the term “private” implies, such accessibility may be exclusive. As an example, when a user utilizes a weather forecast application executed on a cellphone, e.g., The Weather Channel® on iPhone, the user may permit the cellphone to upload a pinpoint geographical location of the user to cloud platform 102. The weather forecast application may instruct cloud platform 102 to store the pinpoint geographical location in cloud cache 104 as private data 206. For security reasons, the stored private data 206 may not be accessible to other applications executed on the same cellphone or other applications on someone else's devices. In accordance with some examples, however, the weather forecast application may authorize access to the stored private data 206 to a number of other applications, e.g., a navigation application, so that the other applications may retrieve the pinpoint geographical location from cloud platform 102 to calculate routing. Moreover, since pinpoint geographical location is stored in cloud cache 104 of low latency and high transfer rate, the user may not need to wait during routing processes.

Service memory 208 may refer to one or more physical memory devices that include one or more cells, each of which may be configured to store identity information of one of applications 108 that has the authority to access a corresponding portion of private data 206. In some examples, each of the one or more cells may be configured to store a modified unique identifier based on a hash function as referenced above. In some examples, service memory 208 may also include the aforementioned disk storage and/or network storage distributed over cloud platform 102.

Unique Identifiers 210 may refer to identity information of each of the applications that have authority to access the corresponding portions of private data 206. The applications that have authority to access private data 206 may include an original application that collected or generated private data 206 and other applications granted authorities, by the original application, to access private data 206. For example, when weather forecast application, as the original application, submits the user's pinpoint geographical location to cloud platform 102, the identity information of the weather forecast application may be stored on service memory 208 as one of unique identifier 210. Moreover, the weather forecast application may authorize access to the stored private data 206 to a number of other applications, e.g., navigation applications. The identity information of the number of other applications may also be stored on service memory 208 as corresponding ones of unique identifiers 210. In accordance with some examples, hash values of unique identifiers 210 may be stored as the identity information of applications 108.

Thus, FIG. 2 shows an example cloud cache 108 that includes data storage 202 that stores general data 204 and private data 206, and service memory 208 that stores unique identifiers 210.

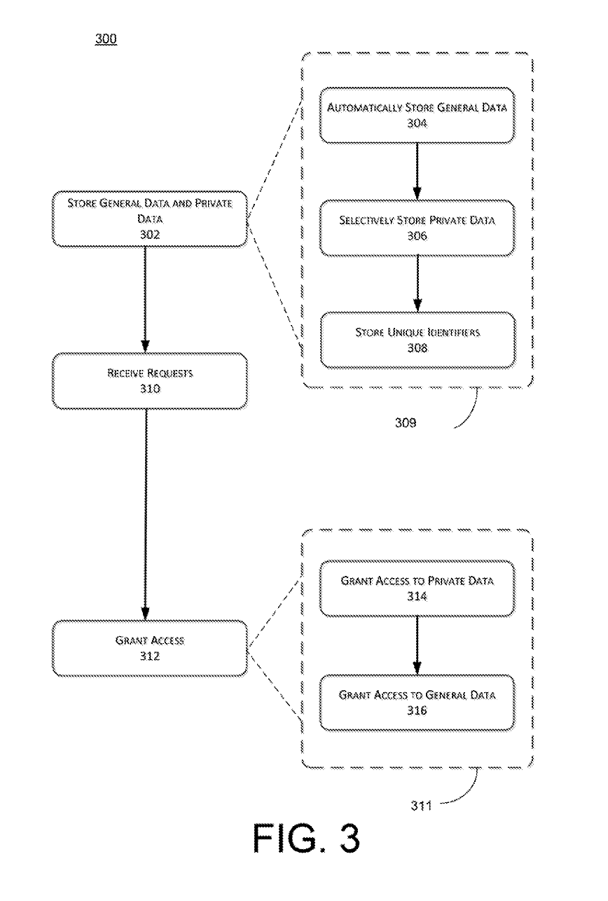

FIG. 3 shows an example configuration 300 of a processing flow of operations by which data cache on a cloud platform may be implemented, arranged in accordance with at least some embodiments described herein. As depicted, processing flow 300 may include sub-processes executed by various components that are part of example systems 100. However, processing flow 300 is not limited to such components, and modification may be made by re-ordering two or more of the sub-processes described here, eliminating at least one of the sub-processes, adding further sub-processes, substituting components, or even having various components assuming sub-processing roles accorded to other components in the following description. Processing flow 300 may include various operation, functions, or actions as illustrated by one or more of blocks 302, 304, 306, 308, 309, 310, 311, 312, 314, and 316. Processing may begin at block 302.

Block 302 (Store General Data and Private Data) may refer to cloud platform 102 storing general data 204 and private data 206 on data storage 202. Block 302 may include block 309 that may indicate a sub-process and further include block 304, block 306, and block 308.

Block 304 (Automatically Store General Data) may refer to cloud platform 102 automatically storing general data 204 on data storage 202. Since general data 204 remains the same contents in response to requests to access from different ones of applications 108, other applications may not need to re-collect or re-generate general data 204 if general data 204 is automatically stored on data storage 202 that is of low latency and high transfer rate and is accessible to all of applications 108. Processing may continue from block 304 to block 306.

Block 306 (Selectively Store Private Data) may refer to cloud platform 102 selectively storing private data 206 on data storage 202. That is, cloud platform 102 may be configured to store private data 206 in response to the instructions, from the original application that generated private data 206, to require cloud platform 102 to store the generated private data 206. Processing may continue from block 306 to block 308.

Block 308 (Store Unique Identifiers) may refer to cloud platform 102 storing unique identifiers 208, each of which identifies one of a subset of applications 108, on service memory 208 of cloud cache 108. The identified ones of applications 108 may refer to the applications that have access to private data 206. In accordance with some examples, since all of applications 108 can access general data 204, the unique identifiers of the applications that can access general data 206 need not to be specifically listed and, thus, may be stored as a wildcard character, e.g., “*,” that indicates every one of applications 108 can access general data 204. Processing may continue from block 308 to block 310.

Block 310 (Receiving Requests) may refer to cloud platform 102 receiving one or more requests, from a requesting application of applications 108, to access private data 206. For example, other than the original application that collected or generated private data 206, other applications of applications 108 may also request to access private data 206. Since some of the requesting applications may be hostile or malicious software programs that intend to misappropriate private data 206, cloud platform 102 may grant access to just the applications whose unique identifiers are stored in service memory 208. Processing may continue from block 310 to block 312.

Block 312 (Grant Access) may refer to cloud platform 102 granting access to the requests to access private data 206. Block 302 may include block 311 that indicates a sub-process and further includes block 314 and block 316.

Block 314 (Grant Access to Private Data) may refer to cloud platform 102 granting access to private data 206 when the unique identifiers of the requesting application of applications 108 matches one of unique identifiers 210 stored in service memory 208. For example, when one of applications 108 request access to a portion of private data 206, e.g., the pinpoint location collected by The Weather Channel®, cloud platform 102 may be configured to compare the identity information of the requesting one of applications 108 with unique identifiers 210. When the identity information of the requesting one of applications 108 matches at least one of unique identifier 210, cloud platform 102 may grant access to the corresponding portion of private data 206. When the identity information of the requesting one of applications 108 does not match any of unique identifier 210, cloud platform 102 may deny access to the corresponding portion of private data 206. Processing may continue from block 314 to block 316.

Block 316 (Grant Access to General Data) may refer to cloud platform 102 granting access to general data 204 when the unique identifiers of the requesting application of applications 108 does not match one of unique identifiers 210 stored in service memory 208 or private data 204 is not available. For example, when the identity information, e.g., unique identifier, of the requesting application does not matches any of unique identifiers that indicate the applications authorized to access the corresponding portion of private data 206, cloud platform 102 may deny the access to the portion of private data 206 and, alternatively, grant the access to general data 204.

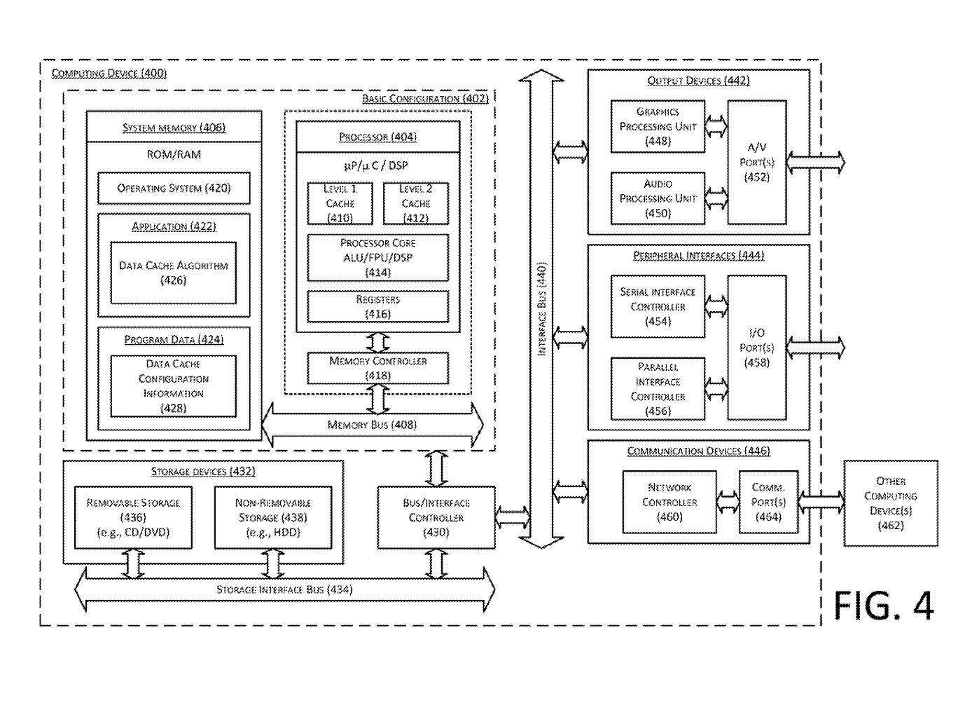

FIG. 4 shows a block diagram illustrating an example computing device 400 that is arranged for data cache on a cloud platform, arranged in accordance with at least some embodiments described herein.

FIG. 4 is a block diagram illustrating an example computing device 400 that is arranged for data cache on a cloud platform in accordance with the present disclosure. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof. System memory 406 may include an operating system 420, one or more applications 422, and program data 424. Application 422 may include a data cache algorithm 426 that is arranged to perform the functions as described herein including those described with respect to example process 300 of FIG. 3 that at least includes blocks 302, 304, 306, 308, 309, 310, 311, 312, 314, and 316. Program data 424 may include data cache configuration information 428 that may be useful for operations with data cache algorithm 426 as is described herein. In some embodiments, application 422 may be arranged to operate with program data 424 on operating system 420 such that implementations of data cache one a cloud platform, e.g., cloud cache 108 that may include data storage 202 and service memory 208, may be provided as described herein. This described basic configuration 402 is illustrated in FIG. 4 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A cloud cache device, comprising:
a service memory that includes one or more cells, each of which is configured to store unique identifiers corresponding to respective ones of plural applications; and
a data storage that is configured to:
store general data that is made accessible to the plural applications regardless of the unique identifiers, and
store private data that is generated by a first one of the plural applications and is made accessible to the respective ones of the plural applications based on verification of a corresponding one of the unique identifiers.

2. The cloud cache device of claim 1, wherein the service memory and the data storage are integrated on a cloud platform that includes one or more network terminals communicatively coupled to one or more servers.

3. The cloud cache device of claim 1, wherein the private data are stored in response to one or more instructions from the first one of the plural applications.

4. The cloud cache device of claim 1, wherein the general data includes at least one of weather forecast information, traffic information, routing information, or a map.

5. The cloud cache device of claim 2, wherein the cloud platform is configured to automatically store the general data.

6. A method, comprising:
storing general data on a data storage of a cloud cache;
storing private data on the data storage of the cloud cache;
storing one or more unique identifiers, each of which identifies a respective one of plural applications, on a service memory of the cloud cache;
receiving one or more requests, from a requesting application of the plural applications, to access the private data;
granting to the requesting application access to the private data based on one of the stored one or more unique identifiers identifying the requesting application; and
granting to the requesting application access to the general data without regard to the one or more unique identifiers.

7. The method of claim 6, wherein the storing general data includes automatically storing the general data.

8. The method of claim 6, further comprising:
receiving private data access authorization information authorizing access to the private data to at least one of the plural applications;
wherein the receiving private data access authorization information and the storing private data are in response to one or more instructions from one of the applications.

9. The method of claim 6, wherein the general data includes at least one of weather forecast information, traffic information, routing information, or a map.

10. The method of claim 6, wherein the service memory includes one or more cells, each of which is configured to store a modified unique identifier based on a hash function.

11. The method of claim 6, wherein the service memory and the data storage of the cloud cache are integrated on a cloud platform that includes one or more network terminals communicatively coupled to one or more servers.

12. The method of claim 6, further comprising granting access to the general data when the private data is not available.

13. The method of claim 7, further comprising receiving the one or more unique identifiers from one of the applications.

14. A computer-readable medium storing instructions that, when executed, cause one or more processors to perform operations comprising:
automatically storing general data on a data storage of a cloud cache;
storing private data on the data storage in response to one or more instructions from one or more applications that generated the private data;
storing one or more unique identifiers, each of which identifies a respective one of plural applications, on a service memory of the cloud cache;
receiving one or more requests, from a requesting application of the plural applications, to access the private data; and
granting to the requesting application access to the private data based on one of the stored one or more unique identifiers identifying the requesting application.

15. The computer-readable medium as recited in claim 14, further comprising granting to the requesting application access to the general data without regard to the one or more unique identifiers.

16. The computer-readable medium as recited in claim 14, further comprising granting access to the general data when the private data are not available.

17. The computer-readable medium as recited in claim 14, further comprising receiving the one or more unique identifiers from at least one of the plural applications that generated the private data.

18. The computer-readable medium as recited in claim 14, wherein the general data is accessible to the plural applications.

19. The computer-readable medium as recited in claim 14, wherein the general data includes weather forecast information, traffic information, routing information, or maps.

20. The computer-readable medium as recited in claim 14, wherein the service memory includes one or more cells, each of which is configured to store a modified unique identifier based on a hash function.
